(19) United States
(12) Patent Application Publication
(10) Pub. No.: US 2021/0209983 A1
(43) Pub. Date: Jul. 8, 2021

(54) DRIVE CIRCUIT AND DISPLAY APPARATUS

(71) Applicant: HKC Corporation Limited, Shenzhen City, Guangdong (CN)

(72) Inventor: Beizhou HUANG, Shenzhen City, Guangdong (CN)

(21) Appl. No.: 16/068,442

(22) PCT Filed: Jan. 23, 2018
(86) PCT No.: PCT/CN2018/073767

§ 371 Date: Jul. 6, 2018

(30) Foreign Application Priority Data
Oct. 12, 2017 (CN) 201710948256.9

(51) Int. Cl. G09G 3/20

(52) U.S. Cl. CPC G09G 3/20; G09G 2330/028; G09G 2320/0276

(57) ABSTRACT

This application provides a drive circuit and a display apparatus. The drive circuit includes: a reference voltage generation unit, configured to provide a first reference voltage; a gamma voltage generation unit, configured to: receive the first reference voltage from the reference voltage generation unit, and output a plurality of gamma reference voltages; and a voltage regulation unit, configured to output a basic voltage, where the voltage regulation unit uses several voltage values in the plurality of gamma reference voltages as a second reference voltage, and the voltage regulation unit regulates the basic voltage according to the second reference voltage.

### BACKGROUND

### Technical Field

This application relates to the field of display technologies, and in particular, to a drive circuit and a display apparatus.

### Related Art

In a thin film transistor (TFT) display, a system mainboard is connected to a control board (C-Board) by using a line, the C-Board is connected to a printed circuit board (PCB) by using a flexible flat cable (FFC), and the PCB is connected to a display area by using a source chip on film (S-COF) and a gate chip on film (G-COF). A drive mode of the display includes: The system mainboard transmits a color (for example, R/G/B) compression signal, a control signal, and a power supply to the C-Board. After the signals are processed by a timing controller (TCON) on the C-Board, the processed signals are transmitted to a source circuit and a gate circuit of the PCB, and necessary data and the power supply are transmitted to the display area by using the S-COF and the G-COF, so that the display obtains the power supply and the signal that are required to display an image.

However, a display task of the display is driven by using a voltage. During display, the display needs to generate a basic voltage VCOM first. Generally, there is a direct value correspondence between the basic voltage COM and voltage values of a highest voltage and a lowest voltage of the gamma reference voltage used for display. In the related art, a reference voltage generation unit of the PCB generates a reference voltage VREF. The reference voltage VREF and a grounded voltage GND are transmitted to a voltage regulation unit, for example, a digital voltage regulator (DVR) or a mechanical voltage regulator (VR). According to a voltage division principle, the voltage regulation unit may regulate the voltages to obtain the required basic voltage VCOM, and output the basic voltage VCOM to a display panel.

However, working voltages of relevant components attenuate with an extension of usage time. In addition, because attenuation speeds of the basic voltage VCOM, the reference voltage VREF, and the gamma reference voltage are different, after the display panel has been used for a long time, the basic voltage VCOM deviates from an optimal voltage value. Value relationships between various voltages obtained by the display panel have deviations. Consequently, a problem such as a flicker is caused.

### SUMMARY

To resolve the foregoing technical problem, an objective of this application is to provide a drive circuit and a display apparatus, so as to improve, by regulating a basic voltage, a problem such as an image flicker displayed on a display panel.

To achieve the objective of this application and resolve technical problems of this application, the following technical solutions are used. A drive circuit is provided according to this application. The drive circuit includes: a reference voltage generation unit, configured to provide a first reference voltage; a gamma voltage generation unit, configured to: receive the first reference voltage from the reference voltage generation unit, and output a plurality of gamma reference voltages; and a voltage regulation unit, configured to output a basic voltage, where the voltage regulation unit uses several voltage values in the plurality of gamma reference voltages as a second reference voltage, and the voltage regulation unit regulates the basic voltage according to the second reference voltage.

To further resolve the technical problems of this application, the following technical measures may be used.

In an embodiment of this application, a quantity of the plurality of gamma reference voltages is n, n is a positive integer greater than 1, and a quantity of the several voltage values in the plurality of gamma reference voltages is greater than 1 and does not exceed n.

In an embodiment of this application, n is 14 or 18.

In an embodiment of this application, the several voltage values in the plurality of gamma reference voltages include an i^{th} gamma reference voltage and a j^{th} gamma reference voltage. The second reference voltage is a difference between the i^{th} gamma reference voltage and the j^{th} gamma reference voltage, where i and j are greater than 1 and do not exceed n, and i and j are not equal.

In an embodiment of this application, i is 1 and j is n.

In an embodiment of this application, the second reference voltage is an average value of the plurality of gamma reference voltages.

In an embodiment of this application, the gamma voltage generation unit includes a plurality of resistor units, there is a signal output end between each two adjacent resistor units of the plurality of resistor units, and the signal output end is configured to output the plurality of gamma reference voltages.

In an embodiment of this application, the gamma voltage generation unit is connected to an amplification unit. The amplification unit is configured to perform voltage signal amplification on the plurality of gamma reference voltages.

In an embodiment of this application, the drive circuit further includes: a voltage average unit, disposed between the reference voltage generation unit and the voltage regulation unit. The voltage average unit is configured to: extract, in the plurality of gamma reference voltages, several voltage values from all voltage values in descending order, and several voltage values from all voltage values in ascending order; and calculate an average of two value groups as the second reference voltage.

In an embodiment of this application, the drive circuit further includes: a voltage selection unit, disposed between the voltage regulation unit and the reference voltage generation unit. The voltage selection unit is configured to take a plurality of samples from several voltage values in the plurality of gamma reference voltages.

In an embodiment of this application, the voltage regulation unit is a digital voltage regulator or a mechanical voltage regulator.

Another objective of this application is a drive circuit, including: a reference voltage generation unit, configured to provide a first reference voltage; a gamma voltage generation unit, configured to: receive the first reference voltage from the reference voltage generation unit and output n gamma reference voltages, where n is 14 or 18; and a voltage regulation unit, configured to output a basic voltage, where the voltage regulation unit uses a difference between a 1^{st} gamma reference voltage and an n^{th} gamma reference voltage as a second reference voltage according to a signal output order of the n gamma reference voltages; and the voltage regulation unit regulates the basic voltage according to the second reference voltage, where the 1^{st} gamma reference voltage is a maximum value in the n gamma reference voltages, and the n^{th} gamma reference voltage is a minimum value in the n gamma reference voltages.

Still another objective of this application is a display apparatus, including: a display panel, where the display panel includes a display area and a fanout area; a printed circuit board, connected to the display panel; a reference voltage generation unit, where the reference voltage generation unit is disposed on the printed circuit board and is configured to provide a first reference voltage; a gamma voltage generation unit, where the gamma voltage generation unit is formed in the fanout area and is configured to: receive the first reference voltage from the reference voltage generation unit and output a plurality of gamma reference voltages; and a voltage regulation unit, where the voltage regulation unit is disposed on the printed circuit board and is configured to output a basic voltage, where the voltage regulation unit uses several voltage values in the plurality of gamma reference voltages as a second reference voltage, and the voltage regulation unit regulates the basic voltage according to the second reference voltage.

In this application, an original process requirement and product costs may be remained without greatly changing an existing manufacturing process. In addition, after the display panel has been used for a long time, the basic voltage VCOM can still be kept to an appropriate voltage value, and an appropriate value correspondence is kept between the basic voltage VCOM and the gamma reference voltage. Therefore, a problem that an image of the display panel flickers and luminance is not stable is resolved, and the problem is caused because the basic voltage deviates from an optimal value.

### BRIEF DESCRIPTION OF THE DRAWINGS

FIG. 1a is an exemplary schematic structural diagram of a configuration of a drive circuit of a display apparatus;

FIG. 1b is an exemplary schematic local structural diagram of a drive circuit of a display apparatus;

FIG. 2 shows a schematic architectural diagram of applying an embodiment to a drive circuit of a display panel according to this application;

FIG. 3 shows a schematic architectural diagram of applying an embodiment to a drive circuit of a display panel according to this application;

FIG. 4 shows a schematic architectural diagram of applying an embodiment to a drive circuit of a display panel according to this application;

FIG. 5 shows a schematic architectural diagram of applying an embodiment to a drive circuit of a display panel according to this application;

FIG. 6 shows a schematic architectural diagram of applying an embodiment to a drive circuit of a display panel according to this application; and

FIG. 7 shows a schematic architectural diagram of applying an embodiment to a display apparatus according to this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout the specification, “on” means that one is located above or below a target component and does not necessarily mean that one is located on the top based on a gravity direction.

To further describe the technical measures taken in this application to achieve the intended application objective and effects thereof, specific implementations, structures, features, and effects of a drive circuit and a display apparatus provided according to this application are described below in detail with reference to the accompany drawings and preferred embodiments.

A display panel in this application may include a first substrate and a second substrate. The first substrate and the second substrate may be, for example, a thin film transistor (TFT) substrate and a color filter (CF) substrate, which are not limited thereto. In some embodiments, the thin film transistor and the color filter in this application may alternatively be formed on a same substrate.

In some embodiments, the display panel in this application may be, for example, a liquid crystal display panel. This is not limited thereto. Alternatively, the display panel may be an OLED display panel, a W-OLED display panel, a QLED display panel, a plasma display panel, a curved-surface display panel, or another display panel.

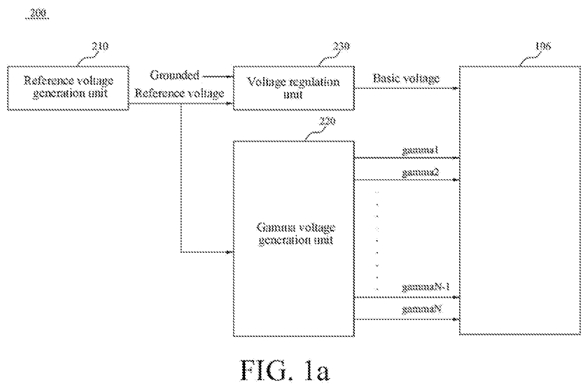

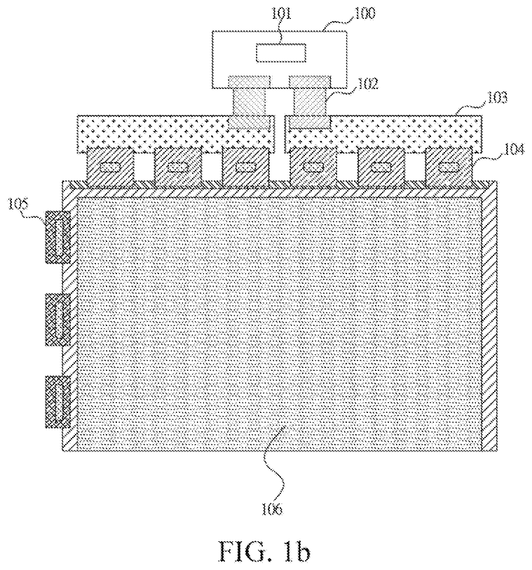

FIG. 1a is an exemplary schematic structural diagram of a configuration of a drive circuit of a display apparatus; and FIG. 1b is an exemplary schematic local structural diagram of a drive circuit of a display apparatus. As shown in FIG. 1a, a drive mode of the display apparatus includes: A system mainboard provides and transmits a color (for example, R/G/B) compression signal, a control signal, and a power supply to a control board 100. After a timing controller (TCON) 101 on the control board 100 processes the signals, the processed signals and the power supply processed by a drive circuit 200 are transmitted to a source circuit and a gate circuit of a printed circuit board 103 by using a flexible flat cable (FFC) 102, and necessary data and the power supply are transmitted to a display area 106 by using a source chip on film 104 and a gate chip on film 105, so that a display obtains the power supply and the signals that are required to display an image.

As shown in FIG. 1b, the drive circuit 200 includes: a reference voltage generation unit 210, a gamma voltage generation unit 220, and a voltage regulation unit 230. The reference voltage generation unit 210 provides a reference voltage Vref to the gamma voltage generation unit 220. After converting the reference voltage Vref, the gamma voltage generation unit 220 outputs a plurality groups of gamma reference voltages: gamma1, gamma2, . . . , gammaN−1, and gammaN (N is usually 18 or 14). The plurality groups of gamma reference voltages are separately provided to the display area 106 of a display panel, so as to drive each pixel circuit of the display panel at different gray scale voltages.

During display, a display needs to generate a basic voltage VCOM first. Generally, there is a direct value correspondence between the basic voltage COM and voltage values of a highest voltage (for example, the foregoing gamma1) and a lowest voltage (for example, the foregoing gammaN) of the gamma reference voltage used for display. In the related art, a reference voltage generation unit 110 generates a reference voltage VREF. The reference voltage VREF and a grounded voltage GND are transmitted to a voltage regulation unit 130. The voltage regulation unit 130 is, for example, a digital voltage regulator (DVR) or a mechanical voltage regulator (VR). According to a voltage division principle, the voltage regulation unit 130 may regulate the voltages to obtain the required basic voltage VCOM, and output the basic voltage VCOM to a display area 106 of the display panel.

However, working voltages of relevant components such as the reference voltage generation unit 110, the gamma voltage generation unit 120, and the voltage regulation unit 130 attenuate with an extension of usage time. In addition, because attenuation speeds of the basic voltage VCOM, the reference voltage VREF, and the gamma reference voltage are different, after the display panel has been used for a long time, the basic voltage VCOM deviates from an optimal voltage value.

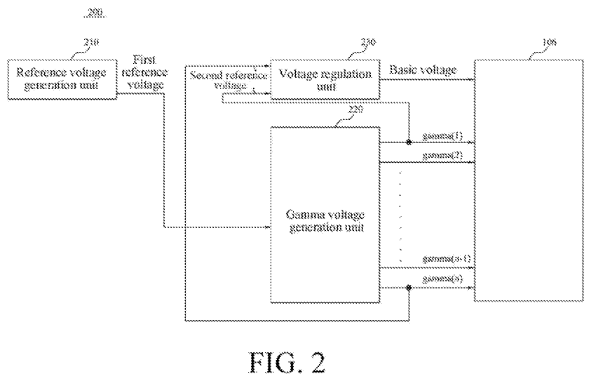

FIG. 2 shows a schematic architectural diagram of applying an embodiment to a drive circuit of a display panel according to this application. In an embodiment of this application, the drive circuit includes: a reference voltage generation unit 210, configured to provide a first reference voltage Vref1; a gamma voltage generation unit 220, configured to: receive the first reference voltage Vref1 from the reference voltage generation unit 210, and output a plurality of gamma reference voltages; and a voltage regulation unit 230, configured to output a basic voltage VCOM, where the voltage regulation unit 230 uses several voltage values in the plurality of gamma reference voltages as a second reference voltage Vref2, and the voltage regulation unit 230 regulates the basic voltage according to the second reference voltage Vref2.

In some embodiments, a quantity of the plurality of gamma reference voltages is n, where n is a positive integer greater than 1, and a quantity of the several voltage values in the plurality of gamma reference voltages is greater than 1 and does not exceed n. Generally, n is 14 or 18. To easily describe the following examples, gamma(1), gamma(2), . . . , gamma(n−1), and gamma(n) are used to represent corresponding gamma reference voltages.

In some embodiments, the quantity of the several voltage values in the plurality of gamma reference voltages is 2. The several voltage values include an i^{th} gamma reference voltage and a j^{th} gamma reference voltage. The second reference voltage is a difference between the i^{th} gamma reference voltage and the j^{th} gamma reference voltage, where i and j are greater than 1 (including 1) and do not exceed n, and i and j are not equal.

In some embodiments, for the second reference voltage, paired samples are taken according to an order in which the voltage regulation unit 230 outputs the plurality of gamma reference voltages. For example, sampling voltages of the second reference voltage Vref2 include a 1^{st} gamma reference voltage gamma(1) and an n^{th} gamma reference voltage gamma(n). Sampling voltages of the second reference voltage Vref2 include a 2^{nd} gamma reference voltage gamma(2) and an (n−1)^{th} gamma reference voltage gamma(n−1). Sampling voltages of the second reference voltage Vref2 include a 3^{rd} gamma reference voltage gamma(3) and an (n−2)^{th} gamma reference voltage gamma(n−2) . . . . The rest can be deduced by analogy.

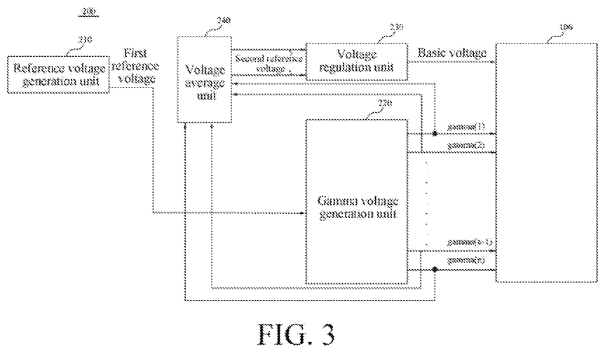

FIG. 3 shows a schematic architectural diagram of applying an embodiment to a drive circuit of a display panel according to this application. In some embodiments, a voltage average unit 240 is disposed between the voltage regulation unit 230 and the reference voltage generation unit 210. The voltage average unit 240 is configured to: extract, in the plurality of gamma reference voltages, several voltage values from all voltage values in descending order, and several voltage values from all voltage values in ascending order; and calculate an average of two value groups as the second reference voltage.

In some embodiments, the second reference voltage Vref2 is an average value of all the gamma reference voltages.

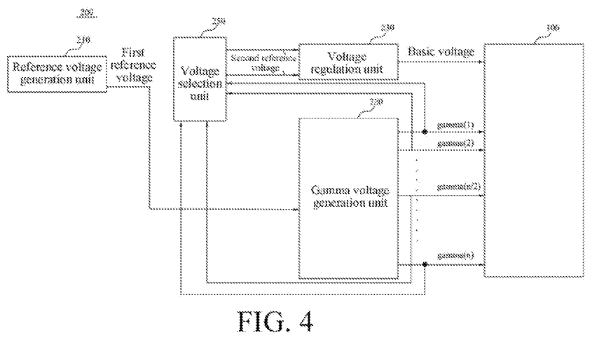

FIG. 4 shows a schematic architectural diagram of applying an embodiment to a drive circuit of a display panel according to this application. In some embodiments, a voltage selection unit 250 is disposed between the voltage regulation unit 230 and the reference voltage generation unit 210. The voltage selection unit is configured to take a plurality of samples from several voltage values in the plurality of gamma reference voltages. For example, the voltage selection unit takes a 1^{st} gamma reference voltage gamma(1), a 2^{nd} gamma reference voltage gamma(2), an (n/2)^{th} gamma reference voltage gamma(n/2), and an n^{th} gamma reference voltage gamma(n) as samples, and selects only two of them as the second reference voltage Vref2. Selection logic of the voltage selection unit 250 is determined according to an actual requirement of a designer, and the selection logic is not limited.

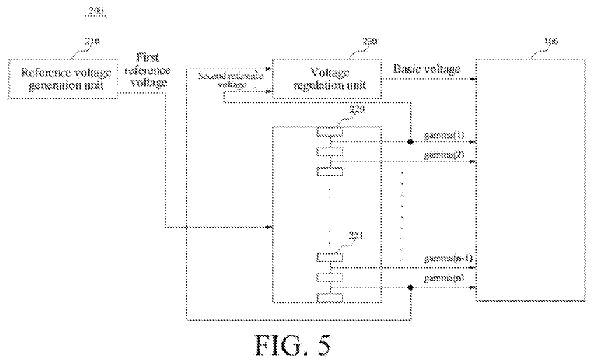

FIG. 5 shows a schematic architectural diagram of applying an embodiment to a drive circuit of a display panel according to this application. In some embodiments, the gamma voltage generation unit 220 includes a plurality of resistor units 221, there is a signal output end between each two adjacent resistor units 221 of the plurality of resistor units 221, and the signal output end is configured to output the plurality of gamma reference voltages.

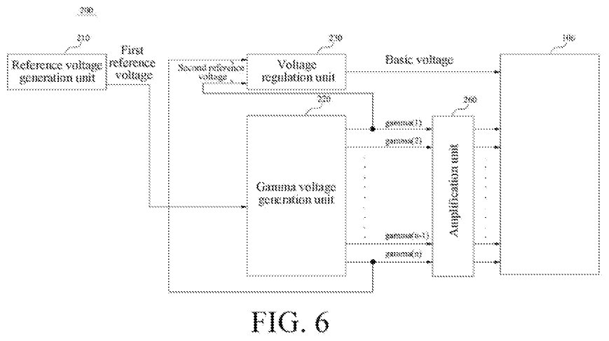

FIG. 6 shows a schematic architectural diagram of applying an embodiment to a drive circuit of a display panel according to this application. In some embodiments, the gamma voltage generation unit 220 is connected to an amplification unit 260. The amplification unit 260 is configured to perform voltage signal amplification on the plurality of gamma reference voltages.

In some embodiments, the voltage regulation unit 230 is a digital voltage regulator or a mechanical voltage regulator.

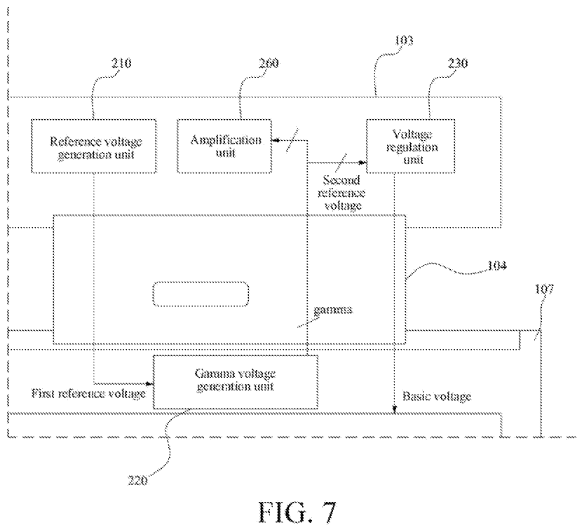

FIG. 7 shows a schematic architectural diagram of applying an embodiment to a display apparatus according to this application. In an embodiment of this application, a display apparatus of this application is provided and includes: a display panel, where the display panel includes a display area 106 and a fanout area 107; a printed circuit board 103, connected to the display panel; a reference voltage generation unit 210, where the reference voltage generation unit 210 is disposed on the printed circuit board 103 and is configured to provide a first reference voltage Vref1; a gamma voltage generation unit 220, where the gamma voltage generation unit 220 is formed in the fanout area 107 and is configured to: receive the first reference voltage Vref1 from the reference voltage generation unit 210 and output a plurality of gamma reference voltages; a voltage regulation unit 230, where the voltage regulation unit 230 is disposed on the printed circuit board 103 and is configured to output a basic voltage VCOM; and an amplification unit 260 disposed on the printed circuit board 103, where after the amplification unit 260 performs voltage signal amplification on the plurality of gamma reference voltages, a necessary power supply is provided and transmitted to a display area 106 through relevant elements such as a source chip on film 104 and a gate chip on film 105; and the voltage regulation unit 230 uses several voltage values in the plurality of gamma reference voltages as a second reference voltage Vref2, and the voltage regulation unit 230 regulates the basic voltage VCOM according to the second reference voltage Vref2.

In some embodiments, a drive circuit of the display apparatus may be any drive circuit in the foregoing embodiments.

In some embodiments, in an embodiment of this application, the drive circuit includes: a reference voltage generation unit 210, configured to provide a first reference voltage Vref1; a gamma voltage generation unit 220, configured to: receive the first reference voltage Vref1 from the reference voltage generation unit 210 and output n gamma reference voltages, where n is 14 or 18; and a voltage regulation unit 230, configured to output a basic voltage VCOM, where the voltage regulation unit 230 uses a difference between a 1^{st} gamma reference voltage gamma(1) and an n^{th} gamma reference voltage gamma(n) as a second reference voltage Vref2 according to a signal output order of the n gamma reference voltages. The voltage regulation unit 230 uses the difference between the 1^{st} gamma reference voltage gamma(1) and the n^{th} gamma reference voltage gamma(n) as the second reference voltage Vref2 according to the signal output order of the n gamma reference voltages. The voltage regulation unit 230 regulates the basic voltage VCOM according to the second reference voltage Vref2, where the 1^{st} gamma reference voltage gamma(1) is a maximum value in the n gamma reference voltages, and the n^{th} gamma reference voltage gamma(n) is a minimum value in the n gamma reference voltages.

In this application, an original process requirement and product costs may be remained without greatly changing an existing manufacturing process. In addition, after the display panel has been used for a long time, the basic voltage VCOM can still be kept to an appropriate voltage value, and an appropriate value correspondence is kept between the basic voltage VCOM and the gamma reference voltage. Therefore, a problem that an image of the display panel flickers and luminance is not stable is resolved, and the problem is caused because the basic voltage deviates from an optimal value.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

The foregoing descriptions are merely preferred embodiments of this application, and are not intended to limit this application in any form. Although this application has been disclosed above through the preferred embodiments, the embodiments are not intended to limit this application. Any person skilled in the art can make some variations or modifications, which are equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A drive circuit, comprising:
a reference voltage generation unit, configured to provide a first reference voltage;
a gamma voltage generation unit, configured to: receive the first reference voltage from the reference voltage generation unit, and output a plurality of gamma reference voltages; and
a voltage regulation unit, configured to output a basic voltage, wherein
the voltage regulation unit uses several voltage values in the plurality of gamma reference voltages as a second reference voltage, and the voltage regulation unit regulates the basic voltage according to the second reference voltage.

2. The drive circuit according to claim 1, wherein a quantity of the plurality of gamma reference voltages is n, n is a positive integer greater than 1, and a quantity of the several voltage values in the plurality of gamma reference voltages is greater than 1 and does not exceed n.

3. The drive circuit according to claim 2, wherein n is 14.

4. The drive circuit according to claim 2, wherein n is 18.

5. The drive circuit according to claim 2, wherein the several voltage values in the plurality of gamma reference voltages comprise an i^{th} gamma reference voltage and a j^{th} gamma reference voltage.

6. The drive circuit according to claim 5, wherein the second reference voltage is a difference between the i^{th} gamma reference voltage and the j^{th} gamma reference voltage, wherein i and j are greater than 1 and do not exceed n, and i and j are not equal.

7. The drive circuit according to claim 6, wherein i is 1 and j is n.

8. The drive circuit according to claim 2, wherein the second reference voltage is an average value of the plurality of gamma reference voltages.

9. The drive circuit according to claim 1, wherein the gamma voltage generation unit comprises a plurality of resistor units, and there is a signal output end between each two adjacent resistor units of the plurality of resistor units.

10. The drive circuit according to claim 9, wherein the plurality of resistor units is configured to output the plurality of gamma reference voltages.

11. The drive circuit according to claim 1, wherein the gamma voltage generation unit is connected to an amplification unit.

12. The drive circuit according to claim 11, wherein the amplification unit is configured to perform voltage signal amplification on the plurality of gamma reference voltages.

13. The drive circuit according to claim 1, further comprising: a voltage average unit, disposed between the reference voltage generation unit and the voltage regulation unit.

14. The drive circuit according to claim 13, wherein the voltage average unit is configured to: extract, in the plurality of gamma reference voltages, several voltage values from all voltage values in descending order, and several voltage values from all voltage values in ascending order; and calculate an average of two value groups as the second reference voltage.

15. The drive circuit according to claim 1, further comprising: a voltage selection unit, disposed between the voltage regulation unit and the reference voltage generation unit.

16. The drive circuit according to claim 15, wherein the voltage selection unit is configured to take a plurality of samples from several voltage values in the plurality of gamma reference voltages.

17. The drive circuit according to claim 1, wherein the voltage regulation unit is a digital voltage regulator.

18. The drive circuit according to claim 1, wherein the voltage regulation unit is a mechanical voltage regulator.

19. A display apparatus, comprising:
a display panel, wherein the display panel comprises a display area and a fanout area;
a printed circuit board, connected to the display panel; and
a drive circuit, comprising:
a reference voltage generation unit, wherein the reference voltage generation unit is disposed on the printed circuit board and is configured to provide a first reference voltage;
a gamma voltage generation unit, wherein the gamma voltage generation unit is formed in the fanout area and is configured to: receive the first reference voltage from the reference voltage generation unit and output a plurality of gamma reference voltages; and
a voltage regulation unit, wherein the voltage regulation unit is disposed on the printed circuit board and is configured to output a basic voltage, wherein
the voltage regulation unit uses several voltage values in the plurality of gamma reference voltages as a second reference voltage, and the voltage regulation unit regulates the basic voltage according to the second reference voltage.

20. A drive circuit, comprising:
a reference voltage generation unit, configured to provide a first reference voltage;
a gamma voltage generation unit, configured to: receive the first reference voltage from the reference voltage generation unit, and output n gamma reference voltages, wherein n is 14 or 18; and
a voltage regulation unit, configured to output a basic voltage, wherein
the voltage regulation unit uses a difference between a 1^{st} gamma reference voltage and an n^{th} gamma reference voltage as a second reference voltage according to a signal output order of the n gamma reference voltages; and the voltage regulation unit regulates the basic voltage according to the second reference voltage, wherein the 1^{st} gamma reference voltage is a maximum value in the n gamma reference voltages, and the n^{th} gamma reference voltage is a minimum value in the n gamma reference voltages.
